(19) United States
(12) Patent Application Publication
(10) Pub. No.: US 2003/0040570 A1
(43) Pub. Date: Feb. 27, 2003

(54) Preparation of pure (meth)acrylic acid and (meth)acrylates

(75) Inventors: Gerhard Nestler, Wien (AT); Juergen Schroeder, Ludwigshafen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Akiengesellschaft, Ludwigshafen (DE)

(21) Appl. No.: 10/207,851

(22) Filed: Jul. 31, 2002

(30) Foreign Application Priority Data
Aug. 13, 2001 (DE) 101 38 630.3

(51) Int. Cl. C08L 31/00

(52) U.S. Cl. 524/558; 526/317.1; 526/319; 524/556; 562/400

(57) ABSTRACT

Pure (meth)acrylic acid and lower (meth)acrylates are prepared from crude (meth)acrylic acid by a process in which I) crude (meth)acrylic acid is separated by crystallization in at least one crystal batch A and at least one mother liquor B and II) at least a part of the crystal batch A is removed as pure (meth)acrylic acid and at least a part of the mother liquor B is used for the preparation of lower (meth)acrylates by esterifying (meth)acrylic acid with the corresponding alcohols in the presence of an acidic catalyst.

The present invention relates to a process for the joint preparation of lower (meth)acrylates and pure (meth)acrylic acid from crude (meth)acrylic acid. The pure (meth)acrylic acid is advantageously used for the preparation of higher (meth)acrylates and/or for the preparation of (meth)acrylic acid-containing (co)polymers. (Meth)acrylates are prepared by esterifying (meth)acrylic acid with the corresponding alcohols in the presence of an acidic catalyst.

The (meth)acrylates obtained by the novel process can advantageously be used in the preparation of the polymer or copolymer dispersions, for example polymer or copolymer suspensions or emulsions.

The pure (meth)acrylic acid obtained can be used, for example, for the preparation of (meth)acrylic acid-containing (co)polymers, preferably for the preparation of polyacrylic acids and in particular for the preparation of superabsorbners.

Polymeric acrylic acid and acrylic acid salts, for example sodium, ammonium or potassium salts, play an important role inter alia as water-insoluble hydrophilic resins, as absorber resins (superabsorbers), in the production of hygiene materials, for example of diapers (EP-A 372 706, page 2, lines 5-14; Modern Superabsorbent Polymer Technology, Chapter 7, Ed. F. L. Buchholz and A. T. Graham, J. Wiley & Sons, Inc., 1998).

The preparation of superabsorbers is generally effected by polymerization of partly or completely neutralized acrylic acid in the presence of a crosslinking agent, as described, for example, in Modern Superabsorbent Polymer Technology, pages 19-24, Ed. F. L. Buchholz and A. T. Graham, J. Wiley & Sons, Inc., 1998.

The acrylic acid used for this purpose generally has to have high purity. Foreign acids, aldehydes and process stabilizers contained in the acrylic acid are particularly troublesome since their presence during the preparation of the superabsorbers results in low molecular weights, low conversions and long reaction times. Furthermore, poor initiation behavior and possibly discolorations are observed from time to time during the polymerization.

The polymers or copolymers prepared on the basis of (meth)acrylates are of considerable industrial importance in the form of polymer dispersions, for example as adhesives, coating materials or textile, leather and paper assistants.

It is generally known that these polymers also contain as a rule undesired volatile organic components, for example impurities from the feedstocks, e.g. lower aldehydes, in particular C₁-C₄-aldehydes, such as formaldehyde, acetaldehyde, propionaldehyde, acrolein, methacrolein and isobutyraldehyde, or furfural, benzaldehyde, acetone, acetic acid, propionic acid, protoanemonin, the alcohol used in the esterification and the corresponding acetates and propionates, which lead inter alia to odor annoyance. These compounds are therefore undesired in many applications, in particular in the food or cosmetics sector or in interior applications, and must be substantially removed, in some cases also because of legal requirements. By an additional treatment of the dispersions, generally referred to as deodorization, an attempt is therefore made to remove these impurities (i.e. residual volatiles) as completely as possible, as described, for example, in DE-A 197 16 373, DE-A 196 21 027 and DE-A 198 28 183. As a rule, a treatment referred to as physical deodorization is carried out, which comprises stripping the dispersion with steam, air, nitrogen or supercritical carbon dioxide, for example in a stirred container (German Published Application DAS 12 48 943) or in a countercurrent column (DE-A 196 21 027). This can be combined with a chemical deodorization, i.e. a postpolymerization by addition of an initiator (DE-A 198 28 183).

Depending on the amount and the boiling points of the components to be separated off, the deodorization is effected in one or more stages. As a rule, the volatile components having a boiling point of up to about 200° C. at atmospheric pressure are substantially separated off.

The removal of such undesired impurities is accordingly an expensive procedure which additionally leads only to unsatisfactory results in the case of high-boiling secondary components and cannot be carried out at all in the case of temperature-sensitive dispersions, suspensions or emulsions.

When, for example, 2-ethylhexyl acrylate is used, the dispersions, suspensions or emulsions contain, inter alia, the high-boiling 2-ethylhexyl ester of acetic acid and of propionic acid. These esters are formed in the preparation of 2-ethylhexyl acrylate by esterifying acrylic acid with the starting alcohol 2-ethylhexanol, since the acrylic acid used generally also contains acetic acid and propionic acid.

When lower (meth)acrylates, i.e. (meth)acrylates of C₁-C₄-alcohols, are used in dispersions, the deodorization is on the other hand less critical since, because they are more readily volatile, the troublesome impurities can be removed by deodorization at lower temperatures.

Acrylic acid is prepared as a rule by catalytic gas-phase oxidation of acrolein, propene and/or propane. Inter alia, acetic acid (0.05-3% by weight) and propionic acid (0.01-1% by weight) and acetone and the other abovementioned impurities generally occur as byproducts. Owing to the small boiling point differences and the high tendency of acrylic acid to polymerization under thermal stress, separation of these byproducts by distillation, as described, for example, in German Laid-Open Application DOS 19 50 750, pages 2-3 and page 4, German Laid-Open Application DOS 21 64 767, pages 3-4 or U.S. Pat. No. 3,844,903, is very difficult or not possible, as is evident from the boiling points bp. of these substances at atmospheric pressure:

| | |
|---|---|
| Acetic acid | bp. 118.1° C. |
| Propionic acid | bp. 141.3° C. |
| Acrylic acid | bp. 141.0° C. |

In the esterification of such an acrylic acid, the esters of acetic acid and of propionic acid are of course also formed. Owing to the small differences in the boiling points and the high tendency of acrylic compounds to polymerize under thermal stress, complete separation is not possible even at the ester stage.

In the case of the n-butyl and 2-ethylhexyl esters, for example, the following boiling points occur at atmospheric pressure:

| | |
|---|---|
| Butyl acrylate | bp. 146.5° C. |
| Butyl acetate | bp. 126.1° C. |
| Butyl propionate | bp. 145.5° C. |
| 2-Ethylhexyl acrylate | bp. about 229° C. |
| 2-Ethylhexyl acetate | bp. 199° C. |
| 2-Ethylhexyl propionate | bp. about 230° C. |

For economic and ecological reasons, the use of (meth)acrylates having very low contents of acetates and propionates would therefore be extremely advantageous in the preparation of polymer dispersions.

JP 200053611-A proposes a thermal treatment of acrylic acid-containing oxidation gas mixture at 300-500° C. in the presence of oxides of molybdenum, of iron, of cobalt and/or of nickel for reducing the propionic acid content of the acrylic acid. The disadvantage there is that the process is expensive, the propionic acid content is reduced only to about 30% of the original value and about 8% of the acrylic acid used are lost. EP-A 1 041 062 proposes reducing the content of C₂-C₄-aldehydes and acetone in (meth)acrylic acid in a stripping column before the distillation.

In principle, substantial removal of the propionic and/or acetic acid is also possible by fractional crystallization of the crude (meth)acrylic acid, as described in EP-A 616 998 or in DE-A1 100 034 98. As a rule, such a crystallization process comprises at least one stripping stage and one rectification stage. However, expensive multistage processes, as in EP-A 616 998, are required for simultaneously achieving high yields and high purities. Dynamic crystallization processes, for example falling-film layer crystallization and/or suspension crystallization, static crystallization processes or combinations thereof are preferably used. The occurrence of undesired precipitates, caused by sparingly insoluble inhibitors (e.g. phenothiazine), maleic acid and/or maleic anhydride, makes it more difficult to carry out these processes. Additional distillation or filtration stages have been proposed for solving this problem, cf. for example DE-A 198 29 477.

The substantially carbonyl-free acrylic acid prepared by such processes is generally referred to as glacial acrylic acid and generally has a purity of at least 99.5% by weight.

However, multi-stage crystallization processes for the preparation of pure (meth)acrylic acid have the disadvantage that they require complicated apparatus and the secondary components accumulate in the mother liquor to such an extent that it has to be discarded, which also leads to losses of the desired product (meth)acrylic acid.

Processes for the preparation of alkyl (meth)acrylates by reacting (meth)acrylic acid with alkanols of 1 to 5 carbon atoms in the homogeneous liquid phase at elevated temperatures and in the presence of proton-donating catalysts are known and are described, for example, in German Laid-Open Applications DOS 1 468 932, 2 226 829 and 2 252 334. These are typical equilibrium reactions in which the conversion of the (meth)acrylic acid and the respective alcohol into the corresponding ester is limited by the equilibrium position. As a result of this, for an economical precedure, on the one hand the water of esterification has to be removed from the reaction zone to shift the equilibrium in favor of the ester formed and, on the other hand, the unconverted starting materials have to be separated from the ester formed and have to be recycled to the reaction zone.

Various measures for increasing the conversion of the (meth)acrylic acid into the corresponding esters have therefore been proposed, for example the use of a larger molar excess of alkanol relative to the (meth)acrylic acid, the removal of the water of reaction by means of an organic entraining agent forming a suitable azeotropic mixture or the extraction of the resulting ester with a suitable solvent during the reaction.

GB-1 017 522 discloses a process for the preparation of n-butyl acrylate. As esterification conditions, GB-1 017 522 recommends a molar ratio of starting alcohol to starting acid of from 2.3 to 5 and a content of from 0.5 to 5% by weight, based on the total mass of the reactants, of catalytically active sulfuric acid or organic sulfonic acid.

U.S. Pat. No. 4,280,010 discloses a process for the continuous preparation of alkyl esters of acrylic acid by reacting acrylic acid and alkanols of 1 to 4 carbon atoms in the liquid phase in a molar ratio of from 1 (alkanol):1 (acrylic acid to 2 (alkanol):1 (acrylic acid) at from 80 to 130° C. and in the presence of sulfuric acid or an organic sulfonic acid as a catalyst.

However, these esterification processes do not reduce the content of byproducts.

It is an object of the present invention to provide an economical and technically simple process for the preparation of (meth)acrylates which can be used in the production of polymer dispersions, so that the dispersions prepared therefrom need not be deodorized or can be deodorized without difficulties, and of (meth)acrylic acid which can be used for a (co)polymerization.

We have found that this object is achieved by a process for the preparation of pure (meth)acrylic acid and lower (meth)acrylates from crude (meth)acrylic acid, wherein I) crude (meth)acrylic acid is separated into at least one crystal batch A and at least one mother liquor B by crystallization and II) at least a part of the crystal batch A is removed as pure (meth)acrylic acid and at least a part of the mother liquor B is used for the preparation of lower (meth)acrylates by esterifying (meth)acrylic acid with the corresponding alcohols in the presence of an acidic catalyst.

It comprises in principle the following stages:

1) Preparation of a crude (meth)acrylic acid by catalytic gas-phase oxidation of propane, propene and/or acrolein or of isobutene and/or methacrolein,

2) separation of the crude (meth)acrylic acid by a one-stage, two-stage or multistage crystallization into a highly pure (meth)acrylic acid (crystals) and a less pure (meth)acrylic acid (mother liquor).

3) Esterification of at least a part of the less pure (meth)acrylic acid (mother liquor) with a lower alcohol and

4a) esterification of at least a part of the highly pure (meth)acrylic acid (crystals) with a higher alcohol and/or

4b) polymerization or copolymerization of at least a part of the highly pure (meth)acrylic acid (crystals) for the preparation of a (meth)acrylic acid-containing polymer.

Lower alcohols are preferably monohydric alcohols of 1 to 4 carbon atoms, e.g. methanol, ethanol, isopropanol, n-propanol, n-butanol, isobutanol, sec-butanol, tert-butanol, ethylene glycol monomethyl ether or ethylene glycol monoethyl ether.

Higher alcohols are preferably alcohols of 6 to 20, particularly preferably 6 to 12, carbon atoms, e.g. n-hexanol, n-heptanol, n-octanol, n-decanol, n-dodecanol, 2-ethylhexan-1-ol, 2-ethylhexane-1,3-diol, 2,4-diethyloctane-1,3-diol, cyclohexanol, cyclooctanol, cyclododecanol, triethylene glycol, diethylene glycol monoethyl ether, dipropylene glycol, tripropylene glycol, tetraethylene glycol or pentaethylene glycol.

The corresponding (meth)acrylates obtained from the higher or lower alcohols are referred to here analogously as higher or lower (meth)acrylates.

(Meth)acrylic acid represents methacrylic acid and acrylic acid.

In the context of this invention, the term “dispersion” is used as a general term for suspensions and emulsions.

In the context of this invention, the term (co)polymers is used as a general term for polymers or copolymers.

Advantages of the novel process are the following:

(Meth)acrylic acid of higher purity is obtained

Higher (meth)acrylates of higher purity are obtained

Economical crude (meth)acrylic acid is used as a starting material

Only a few crystallization stages are required

No stripping stages are required

There are no substantial losses of (meth)acrylic acid

No additional distillation/filtration stages are required

Starting from the higher (meth)acrylates, it is possible to prepare dispersions which need not be deodorized.

The crude (meth)acrylic acid is prepared in a manner known per se, as a rule by heterogeneously catalyzed gas-phase oxidation.

An acrylic acid-containing product gas mixture is obtainable in a manner known per se by a heterogeneously catalyzed gas-phase partial oxidation of at least one C₃ precursor of acrylic acid with molecular oxygen at elevated temperatures.

For this purpose, in the preparation of the acrylic acid, the starting gas is as a rule diluted with gases inert under the chosen reaction conditions, e.g. nitrogen (N₂), CO₂, saturated C₁-C₆-hydrocarbons and/or steam and is passed, as a mixture with molecular oxygen (O₂) or an oxygen-containing gas, at elevated temperatures (usually from 200 to 450° C.) and, if required, superatmospheric pressure over solid, transition metal-containing (e.g. Mo- and V- or Mo-, W-, Bi- and Fe-containing) mixed oxide catalysts and is converted by oxidation into acrylic acid. These reactions can be carried out in one or more stages with in each case 1, 2 or more reaction zones and/or catalyst beds, which may have a composition and/or reactivity variable from reaction zone to reaction zone. In this context, cf. for example DE-A 19 62 431, DE-A 29 43 707, DE-C 12 05 502, EP-A 257 565, EP-A 253 409, DE-A 22 51 364, EP-A 117 146, GB-B 1 450 986 and EP-A 293 224.

The product gas mixture according to the invention is preferably obtained from the partial oxidation of propane, propene and/or acrolein.

The hot reaction gas mixture formed contains a high proportion of noncondensable components, such as carbon oxides, nitrogen and oxygen, in addition to the (condensable) acrylic acid and condensable secondary components, e.g. acetic acid, propionic acid, acetone, the abovementioned lower aldehydes and water.

Numerous methods are known for separating the acrylic acid from such a reaction gas mixture. Thus, for example in DE-C 21 36 396 or DE-A 24 49 780, the acrylic acid is separated from the reaction gases obtained in the catalytic gas-phase oxidation by countercurrent absorption with a high-boiling hydrophobic solvent. The crude acrylic acid is separated by distillation from the resulting acrylic acid-containing mixture. Absorption of acrylic acid in high-boiling solvents is also described, for example, in German Laid-Open Applications DOS 2 241 714 and DOS 43 08 087.

German Laid-Open Application DOS 2 241 714 describes the use of esters of aliphatic or aromatic mono- or dicarboxylic acids which have a melting point of below 30° C. and a boiling point above 160° C. at atmospheric pressure.

German Laid-Open Application DOS 43 08 087 recommends the use of a high boiling mixture comprising from 0.1 to 25% by weight of dimethyl orthophthalate, based on a mixture consisting of from 70 to 75% by weight of diphenyl ether and from 25 to 30% by weight of biphenyl, for separating acrylic acid from reaction gases of the catalytic oxidation by countercurrent absorption.

These processes essentially comprise substantially absorbing the acrylic acid contained in the reaction gas mixture and the condensable byproducts in a solvent or solvent mixture, for which a countercurrent absorption is preferably used, then partially stripping the low-boiling components, e.g. low-boiling aldehydes, such as acetaldehyde, propionaldehyde or acrolein, acetone, acetic acid or propionic acid, for which a countercurrent desorption is preferably used, and finally separating off the acrylic acid from the solvent by distillation. A crude acrylic acid separated in this manner from solvent is preferably used for the novel process.

In a preferred embodiment, the purification of the acrylic acid/solvent mixture is carried out as follows:

The feed of the distillative separation (rectification) contains acrylic acid as a rule in an amount of from 5 to 30, preferably from 10 to 20, % by weight.

A preferably used solvent is a mixture of from 0.1 to 25% by weight of dimethyl orthophthalate, based on a mixture consisting of from 72 to 75% by weight of diphenyl ether and from 25 to 30% by weight of biphenyl.

In principle, all columns comprising internals having separation activities are suitable as rectification columns. Suitable column internals are all conventional internals, in particular trays, stacked packings and/or dumped packings. Among the trays, bubble trays, sieve trays, valve trays, Thormann trays and/or dual-flow trays or any desired combinations thereof are preferred.

Preferably, the rectification is carried out in tray columns having, for example, 25 to 50, preferably from 30 to 40, trays and having external circulation evaporators, the feed generally being in the lower fourth of the column.

The acrylic acid is discharged in liquid form by a side take-off in the upper half of the column. The low boilers still present (e.g. water, acetic acid, propionic acid) are separated off in gaseous form via the top of the column and are condensed, it being possible to recycle a part of the condensate as reflux into the column.

The isolation of the acrylic acid by distillation is preferably effected at reduced pressure. A top pressure of not more than 500, usually 10-200, preferably 10-100, hPa is expediently employed. In a corresponding manner, the associated temperatures are as a rule 100-230° C. in the bottom of the column at 30-80° C. at the top of the column.

In order to support and to stabilize the separation process, an oxygen-containing gas, preferably air, may flow through the rectification column.

The crude acrylic acid taken off as a medium boiler fraction comprises substantially the components which, at atmospheric pressure, have a boiling point in the temperature range of, for example, from 120 to 160° C., in particular in the range from +/−10° C. from that of the desired product acrylic acid, i.e. from about 130 to 151° C.

Other processes provide total condensation of the (condensable) oxidation products and of the water of reaction or absorption in water. The resulting aqueous acrylic acid solution can be further worked up by distillation with an azeotropic agent (cf. for example DE-C-34 29 391 and JP-A-1 124 766) or by an extraction method (cf. for example DE-A-21 64 767 and JP-A-5 81 40 039). In EP-A 551 111, the acrylic acid-containing reaction gas mixture is brought into contact with water in an absorption tower and the aqueous solution obtained is distilled in the presence of a solvent which forms an azeotropic mixture with water. In each case, crude acrylic acid remains as a residue.

A further process consists in separating the crude acrylic acid from the hot oxidation gases directly by fractional condensation (DE 197 40 253 and the German Patent Application with the application number 100 53 086.9).

In the further purification of the acrylic acid by crystallization, the resulting mother liquor can also be fed back to the column as a reflux, preferably below the take-off of the medium boiler fraction.

The preparation or working-up process by which the crude (meth)acrylic acid used was obtained is unimportant with regard to carrying out the novel process.

The crude acrylic acid used in the novel process may contain, for example, the following components:

| | | |
|---|---|---|
| Acrylic acid | 90-99.9% | by weight |
| Acetic acid | 0.05-3% | by weight |
| Propionic acid | 0.01-1% | by weight |
| Diacrylic acid | 0.01-5% | by weight |
| Water | 0.05-10% | by weight |
| Furfural | 0.01-0.1% | by weight |
| Benzaldehyde | 0.01-0.05% | by weight |
| Other aldehydes | 0.01-0.3% | by weight |
| Inhibitors | 0.01-0.1% | by weight |
| Maleic acid | 0.001-0.5% | by weight |
| (anhydride) | | |

Methacrylic acid can be prepared analogously to acrylic acid by gas-phase oxidation of C₄ starting compounds. Isobutene, isobutane, tert-butanol, methacrolein or methyl tert-butyl ether is particularly advantageously used. Inter alia, mixed oxides based on molybdenum, vanadium, tungsten and/or iron have proven useful as catalysts. The preparation of methacrolein by reacting propionaldehyde with formaldehyde is also known (EP-A 92 097). The methacrolein obtained in this manner can be oxidized in a conventional manner in the gas phase to give methacrylic acid (see above).

The reaction mixture obtained in the gas-phase oxidation contains, in addition to methacrylic acid, unconverted methacrolein, acetic acid, propionic acid, acrylic acid, further aldehydes, maleic acid and/or the anhydride thereof, steam, carbon oxides, nitrogen and oxygen. The crude methacrylic acid can be isolated from the reaction gas mixture analogously to the abovementioned acrylic acid process, for example by partial total condensation, absorption in a high-boiling solvent (e.g. ethylhexanoic acid) or in water, or by fractional condensation.

The crude methacrylic acid contains, as a rule, mainly the following components:

| | | |
|---|---|---|
| Methacrylic acid | 90-99.9% | by weight |
| Acetic acid | 0.05-3% | by weight |
| Propionic acid | 0.01-1% | by weight |
| Acrylic acid | 0.01-1% | by weight |
| Water | 0.05-5% | by weight |
| Aldehydes | 0.01-0.1% | by weight |
| Inhibitors | 0.01-0.1% | by weight |

The separation of the crude (meth)acrylic acid by crystallization can be effected by known dynamic and/or static processes, as described, for example in Ullmann's Encyclopedia of Industrial Chemistry, Sixth Edition, 2000 Electronic Release, Chapter: Crystallization and Precipitation, Section 5 (Crystallization from Solutions), Section 6 (Crystallization from Melts) and Section 10 (Miscellaneous Crystallization Techniques).

The crystallization process used for the crystallization is not subject to any restriction. It may be carried out continuously or batchwise, in one or more stages, and, if required, may be combined with a distillation, as described in DE-A 198 29 477. Processes as described in U.S. Pat. No. 4,493,719, EP-A 776 875, EP-A 715 870 or EP-A 648 520 may also be used.

In a possible embodiment, the crystallization is carried out as a fractional (multistage) crystallization. In fractional crystallization, all stages which produce crystals which are purer than the mixture fed in and containing acrylic acid or methacrylic acid are usually referred to as purification stages and all other stages as stripping stages. Expediently, multistage processes are operated here by the countercurrent principle, in which, after the crystallization in each stage, the crystals are separated from the mother liquor and these crystals are fed to the respective stage with the next highest purity, while the crystallization residue is fed to the respective stage with the next lowest purity.

In a preferred embodiment of the invention, the crystallization is effected in apparatuses in which the crystals grow on cooled surfaces in the crystallization apparatus, i.e. are fixed in the apparatus (e.g. dynamic layer crystallization process from Sulzer Chemtech or static crystallization process from BEFS PROKEM). The crystallization can be carried out dynamically and/or statically (see below), a combination of dynamic and static crystallization being possible. In the latter embodiment, the residue of the dynamic crystallization is preferably fed to the static crystallization and the crystals of the static crystallization to the dynamic crystallization, as described in EP-A 616 998. The method of carrying out the dynamic and/or static crystallization is not critical here. In the static crystallization, the liquid phase is moved only by free convection, whereas in the dynamic crystallization the liquid phase is moved by forced convection. The latter can be effected by forced flow in apparatuses which flow through the full cross-section (cf. for example German Laid-Open Application DOS 2 606 364) or by applying a trickle film or falling film to a cooled wall (cf. for example DT 1 769 123 and EP-A-0 218 545).

Suitable dynamic processes are, for example, a suspension crystallization, a falling-film layer crystallization, a layer crystallization of the type comprising flow through the full tube cross-section, a layer crystallization on moving cooling surfaces (cooling belt, chill roll) or countercurrent crystallization.

The dynamic crystallization process can be operated continuously or batchwise. Preferably, the suspension crystallization and the layer crystallization are carried out on moving cooling surfaces while the falling-film layer crystallization and the layer crystallization of the type with flow through the full tube cross-section are operated batchwise.

The heat removal during the dynamic crystallization processes can preferably be effected by cooling apparatus walls or by partial evaporation of the crystallizing solution under reduced pressure. Particularly preferably, the heat removal is effected by indirect cooling by means of heat exchanger surfaces. All mixtures suitable for this purpose, in particular water/methanol or water/glycol mixtures, can be used as heat transfer media.

Advantageously, the temperature of the mother liquor during the dynamic crystallization is from −30 to +15° C., in particular from −10 to +15° C., particularly preferably from −5 to +14° C.

The solids content in the crystallizer is advantageously from 5 to 85, preferably from 25 to 80, g of solid/100 g.

The suspension crystallization is a crystallization process in which single crystals are formed in the mass of the starting material from a liquid multicomponent system of starting material through heat removal. The crystal suspension containing the mother liquor and the dispersed single crystals as the solid phase must be agitated during the suspension crystallization process, circulation or stirring being particularly suitable for this purpose. Adhesion of crystals to surfaces is not necessary and is even undesirable in this case. Since the crystal suspension has to be agitated, the suspension crystallization is included among the dynamic crystallization processes.

In the suspension crystallization by indirect cooling, the heat is removed via scraped-surface coolers which are connected to a stirred kettle or container without a stirrer. The circulation of the crystal suspension is ensured here by a pump. It is also possible to remove the heat via the wall of a stirred kettle having a stirrer passing close to the wall. A further preferred embodiment in the case of the suspension crystallization is the use of cooling-disk crystallizers, as produced, for example, by GMF (Gouda, The Netherlands).

In a further suitable variant for crystallization by cooling, the heat is removed via conventional heat exchanger (preferably tube-bundle or plate-type heat exchanger). In contrast to scraped-surface coolers, stirred kettles having stirrers passing close to the wall or cooling-disk crystallizers, these apparatuses have no means for avoiding crystal layers on the heat-transfer surfaces. If a state in which the thermal resistance assumes too high a value during operation as a result of crystal layer formation, switching to a second apparatus occurs. During the operating time of the second apparatus, the first apparatus is regenerated (preferably by melting off the crystal layer or flushing the apparatus with unsaturated solution). If too high a thermal resistance is reached in the second apparatus, switching back to the first apparatus occurs, etc. This variant can also be operated cyclically with more than two apparatuses. In addition, the crystallization can be carried out by conventional evaporation of the solution under reduced pressure.

All known solid-liquid separation methods are suitable for separating the resulting solid-liquid mixture. Preferably, the crystals are separated from the mother liquor by filtration, settling out and/or centrifuging. For the case of the layer crystallization or the static crystallization, separation of the crystals from the mother liquor can be effected in the crystallization apparatus itself since the crystals are fixed in the apparatus and the mother liquor can be removed by allowing it to flow out of the apparatus. The crystals are removed from the crystallization apparatus by melting the crystals and then allowing the melt to flow away. For the case of the suspension crystallization, all known solid-liquid separation methods are suitable. Preferably, the crystals are separated from the mother liquor by filtration and/or centrifuging. Advantageously, the filtration, settling out or centrifuging is preceded by a thickening of the suspension, for example by means of hydrocyclones. All known centrifuges which operate batchwise or continuously are suitable for centrifuging.

Reciprocating-conveyor centrifuges which can be operated in one or more stages are particularly advantageously used. Helical screen centrifuges or helical-conveyor centrifuges (decanters) are also suitable. Filtration is advantageously effected by means of suction filters which are operated continuously or batchwise, with or without stirrer, or by means of belt filters. In general, the filtration can be effected under superatmospheric or reduced pressure.

The separation is preferably effected by means of reciprocating-conveyor or helical-conveyor centrifuges (decanters) or belt filters.

During and/or after the solid-liquid separation, further process steps for increasing the purity of the crystals or of the crystal cake may be provided. One-stage or multistage washing and/or sweating of the crystals or of the crystal cake can particularly advantageously be carried out after separation of the crystals from the mother liquor. The wash liquid used is not subject to any restriction here. However, washing is advantageously effected using pure material, i.e. using a liquid which contains (meth)acrylic acid whose purity is higher than that of the mother liquor. The washing can be effected in apparatuses customary for this purpose, for example scrubber columns, as described, for example, in German Patent Applications with the application numbers 100 39 025.0 or 100 36 881.6 or in DE-A 100 17 903, in which the separation of the mother liquor and the washing are effected in one apparatus, in centrifuges which can be operated in one or more stages or in suction filters or belt filters. Washing with water is also possible. The washing can be carried out on centrifuges or belt filters in one or more stages, the wash liquid preferably being fed countercurrently to the crystal cake.

Sweating for increasing the purity of the crystals, which involves local melting of contaminated regions, can be carried out alongside or over and above. In the suspension crystallization, it is particularly preferable to carry out the sweating on centrifuges or belt filters, but carrying out a combination of washing and sweating in one apparatus may also be suitable.

The mass ratio of wash liquid to crystals is as a rule from 0.1 to 1, particularly preferably from 0.2 to 0.6, kg of wash liquid per 1 kg of crystals. There are no restrictions when carrying out the dynamic layer crystallization, preferably a falling-film layer crystallization or a layer crystallization of the type with flow through the full tube cross-section. The dynamic layer crystallization on stationary cooling surfaces can preferably be carried out as follows: the crystals of the acid are applied to the cooling surface so that the cooling surface is brought into contact with a liquid mixture which contains the acid to be purified, and the corresponding crystals are formed by cooling the cooling surface. For the formation of the crystals, the cooling surface is preferably cooled in a temperature range up to 60° C. below the melting point of the crystals, preferably up to 30° C. below. On reaching the desired crystal mass, the cooling process is terminated. The uncrystallized residual liquid having a lower concentration of the desired acid can then be discharged and hence removed from the cooling surfaces or the crystals formed. The discharge of the residual liquid can be effected by simply allowing it to flow away or pumping it away.

A washing and/or sweating step can then be carried out, if required several times, as described above. During washing, the crystals which have grown on the cooling surfaces are brought into contact with a wash liquid and are separated from the latter again. The residual liquid remaining on the crystals is thus exchanged for the preferably purer wash liquid. Particularly in the case of a relatively long residence time of the wash liquid on the crystals, exchange of impurities between the purer wash liquid and less pure regions of the crystals by diffusion also takes place. The wash liquid used is preferably a fresh, liquid mixture, which contains the acid to be purified, or pure melt of the acid.

During sweating, after a discharge of the residual liquid, the temperature of the crystals on the cooling surface is increased to a value which is between the freezing point of the residual liquid having a lower concentration of the desired acid and the melting point of the pure acid.

The sweating is particularly advantageous when the crystals of the acid are present not as a compact crystal layer but as a porous bed having a large number of inclusions. Thereafter, the crystals can be liquefied by heating and the resulting liquid enriched with desired acid can be discharged, which once again can be effected, for example, by simply allowing it to flow away or pumping it away. The liquefaction of the crystals is preferably effected in a temperature range of up to 40° C. above the melting point of the respective acid, in particular up to 20° C. above.

The cooling surfaces which can be used in the dynamic layer crystallization are not subject to any restriction per se and may be of any desired form. One or more cooling surfaces, for example tubes or flat cooling surfaces, may be used. Here, either the cooling surfaces may be completely immersed in the liquid from which the desired acid is to be purified or a trickle film of this liquid may flow over said cooling surfaces, for example a tube with complete flow-through or a tube through or over which trickle film flows. The cooling surfaces may also be parts of a heat exchanger which are provided with a feed and a discharge. The falling-film layer crystallization can be carried out, for example, as described in EP-A 616 998.

The crystallization can be carried out in one or more stages, preferably from one to three stages, particularly preferably from one or two stages. If the crystallization is carried out in a plurality of stages, for example from two to six stages, preferably from two to four stages, particularly preferably from two or three stages, it may be dynamic or static or may have a combination of dynamic and static stages, in particular in alternation.

A layer crystallization or a static crystallization is preferably carried out.

The crystals and mother liquors produced at every stage in a multistage crystallization can either be purified or only a part thereof can be used for an esterification, if required after further treatment by, for example, washing or sweating.

The crystals and mother liquor are separated in any desired weight ratios, preferably 20-80:80-20, particularly preferably 30-70:70-30, in particular 40-60:60-40, depending on demand for crystals and mother liquor.

The crystallization is carried out as a rule without addition of a solvent, in particular without addition of an organic solvent. If required, water may be added prior to a crystallization to the crude (meth)acrylic acid to be purified by crystallization (up to 10% by weight or more, preferably up to 5% by weight, based on the amount of (meth)acrylic acid contained). Such an addition generally facilitates the removal of lower carboxylic acids, e.g. acetic acid or propionic acid, contained as a byproduct in the crude (meth)acrylic acid, since said acid is incorporated in relatively small amounts in the acrylic acid crystals in the presence of water. Moreover, the presence of water reduces the tendency to crust formation in the crystallizer.

It may furthermore be advantageous if the crystallization of the crude (meth)acrylic acid to be purified is carried out in the presence of an alcohol of one to four carbon atoms, preferably in the presence of the alcohol with which esterification is to be effected in the subsequent stage. Up to 10% by weight of more, preferably up to 5% b weight, of this alcohol are added.

In a further preferred embodiment, a part of the mother liquor which is obtained from the crystallization and is not used for the esterification with a lower alcohol can be recycled into the distillative purification of the (meth)acrylic-containing reaction gas mixture upstream of the crystallization and can be used there, for example, as reflux.

In a further embodiment, a part of the mother liquor which is obtained from the crystallization and is not used for the esterification with a lower alcohol can be passed into a process step in which the reaction gas mixture of the oxidative preparation of the (meth)acrylic acid is absorbed in an absorbent. Such an absorbent may be, for example, biphenyl, diphenyl ether or a phthalate or a mixture thereof, or water. The absorption is known per se to a person skilled in the art. A part of the mother liquor which is obtained from the crystallization can also be passed into a process step in which the laden absorbent is subjected to a desorption in which the absorbent is treated with a gas in order to reduce the content of readily volatile components, e.g. acetaldehyde, propionaldehyde, acrolein or acetone.

The mother liquors or crystals obtained from the crystallization have, as a rule, the following compositions:

| | Crystals | | Mother liquor | |
|---|---|---|---|---|
| (Meth) acrylic acid | 99.7-99.9% | by weight | 85-99.7% | by weight |
| Acetic acid | 50-1 000 | ppm | 0.1-5% | by weight |
| | | by weight | | |
| Propionic acid | 10-500 | ppm | 0.02-2% | by weight |
| | | by weight | | |
| Acrylic acid | 10-500 | ppm | 0.02-2% | by weight |
| (in methacrylic acid) | | by weight | | |
| or diacrylic acid | | | | |
| (in acrylic acid) | | | | |
| Water | 50-1 000 | ppm | 0.1-5% | by weight |
| | | by weight | | |
| Aldehydes | 1-500 | ppm | 0.02-0.2% | by weight |
| | | by weight | | |
| Inhibitors | 1-100 | ppm | 0.02-0.2% | by weight |
| | | by weight | | |
| Maleic acid | 1-200 | ppm | 10-10 000 | ppm |
| (anhydride) | | by weight | | by weight |

The preparation of (meth)acrylates can be carried out by any of the known processes for the esterification of (meth)acrylic acid with alcohols in the presence of inhibitors and strong acids.

The formation of the ester of acrylic acid and alcohol is known to be based on an equilibrium reaction. In order to obtain economical conversions, as a rule one feedstock is used in excess and/or the resulting water of esterification and/or the desired ester is removed from the equilibrium. In order to accelerate or to facilitate the removal of water, an organic solvent which forms an azeotropic mixture with water is frequently added. Particularly the esterification with higher alcohols is advantageously carried out in the presence of an additional entraining agent for the water of reaction (cf. for example W. Bauer jr. in Kirk-Othmer—Encyclopedia of Chemical Technology, Fourth Edition 1994, Vol. 1, S. 301-302, Ullmann's Encyclopedia of Industrial Chemistry, 5th Ed., 1985, Vol. A1, 168 et seq., U.S. Pat. No. 2,917,538, U.S. Pat. No. 5,386,052). Inert hydrocarbons, e.g. cyclohexane, hexane, benzene and toluene, are preferably used as entraining agents for this purpose.

In principle, any esterification process known in the prior art can be used for carrying out the novel esterification process, preferably those mentioned in this application and those mentioned at the outset in the description.

For example, the following esterification processes are particularly suitable:

Esterification process according to DE-A 195 10 891 in the presence of from 5 to 20% by weight of an acidic catalyst, which promotes the cleavage of oxyesters formed as further byproducts during the esterification.

Process according to EP-A 765 859 having a reaction zone comprising a cascade of at least two preferably continuously operated reaction regions connected in series.

A process and an apparatus for the continuous preparation of alkyl esters of (meth)acrylic acid according to DE-A 196 04 252, by reacting (meth)acrylic acid and alcohols in a molar ratio of from 1:0.75 to 1:2 in the homogeneous, liquid, solvent-free phase at elevated temperatures and in the presence of an acidic esterification catalyst.

Process for the continuous preparation of n-butyl acrylate substantially free of acrylic acid, according to EP-A 779 268, in which acrylic acid and n-butanol are reacted in a molar ratio of from 1:1 to 1:1.7 in the presence of an acidic esterification catalyst in an esterification reactor.

The esterification can be carried out continuously or batchwise, as a rule in one or more reactors (cascades) connected in series, the reactors having attached distillation columns with condensers and separation vessels. The heat is supplied in a conventional manner, for example by double-wall heating, external or internal heat exchangers, etc. The thorough mixing of the reaction mixture is effected by stirring, pumped circulation or natural circulation. The distillation columns are provided with the conventional internals having separation activity, for example dual-flow trays, sieve trays, bubble trays, dumped packings or stacked packings. The condensers are usually plate-type or tube-bundle condensers. The starting materials are fed in individually or together, the (meth)acrylic acid, if required a solvent (entraining agent) and a catalyst being fed directly into the reactor/the reactor cascade and the alcohol being fed either into the reactor or via the attached column. The (meth)acrylic acid is stabilized as a rule with 300-1,000 ppm of phenothiazine.

Suitable acidic catalysts are, for example, sulfuric acid, organic sulfonic acids, e.g. para-toluenesulfonic acid, methanesulfonic acid, trifluoromethanesulfonic acid, xylenesulfonic acid or dodecylbenzenesulfonic acid, acidic ion exchangers or acidic metal oxides.

Typical esterification conditions are:

| | |
|---|---|
| Stoichiometry | Alcohol: (meth) acrylic acid = 1:0.7-1.3 |
| (molar) | |
| Catalyst | Sulfuric acid or sulfonic acids (preferably |
| | p-toluenesulfonic acid or |
| | dodecylbenzenesulfonic acid) |
| Amount of catalyst | 0.1-10% by weight, based on feedstocks |
| | (preferably 0.5-5% by weight) |
| Stabilization | 200-2 000 ppm of phenothiazine (based on |
| | feedstocks) |
| Amount of solvent | 0-50% by weight (based on reaction |
| | mixture) |
| Reaction | 80-160° C., preferably 90-130° C. |
| temperature | |
| Reaction time | 1-10, preferably 1-6, hours |
| Pressure | Atmospheric, superatmospheric or reduced |
| | pressure |

The water formed during the esterification is removed and condensed via the column(s) attached to the reactor/the reactors, the condensate, where the alcohol used has sufficient low water solubility, separating into an aqueous phase and an organic phase, containing mainly alcohol, (meth)acrylate, acetate, propionate and any solvent. The aqueous phase and, if required, part of the organic phase are separated off and the organic phase (or the remaining part) is fed as reflux to the top of the column. In the case of readily water-soluble alcohols, e.g. methanol or ethanol, the distillate does not separate into two phases. Processes for the preparation of, for example, methyl or ethyl (meth)acrylate are described, for example, in U.S. Pat. No. 5,187,308, U.S. Pat. No. 4,280,010 or U.S. Pat. No. 4,464,229.

The reactor discharge, containing substantially desired ester, (meth)acrylic acid, low boilers, any solvent (entraining agent), catalyst and high-boiling byproducts, can be washed with water and/or aqueous alkali solution, the catalyst and the unconverted acrylic acid being substantially separated off.

The catalyst can also be separated off by distillation during working-up, as described in DE-A 196 04 252 or DE-A 196 04 253, or via the column attached to the reactor, as described in EP-A 779 268 (corresponding to U.S. Pat. No. 5,877,345), U.S. Pat. No. 5,990,343 or the German Patent Application with the application number 100 63 510.5.

The ester phase purified in this manner is separated, in a distillation unit known per se, into a bottom product, which contains mainly the desired ester and the high-boiling byproducts, and a top product (low boiler), containing substantially water, alcohol, acetate, ether of the alcohol and (meth)acrylate. Where a solvent is used, it is separated off beforehand in a suitable distillation step and recycled to the esterification.

Some of the low boiler fraction can be fed as reflux back to the column and some of said fraction can be fed to the first esterification reactor via the attached column or said low boiler fraction can be separated in a further distillation step into an alcohol-containing phase, which is recycled to the esterification, and a bottom phase, which is discharged.

The desired ester is separated as top product from the bottom product in a further distillation unit. The condensate (desired ester) is stabilized with 10-20 ppm of a suitable stabilizer, e.g. hydroquinone monomethyl ether or hydroquinone, and can be partly fed as reflux back to the column, onto the uppermost tray.

Bottom products of the working-up process, containing substantially desired ester, high-boiling byproducts, catalyst, inhibitors and oligomeric and polymeric (meth)acrylates can be cleaved in the presence of the abovementioned acidic catalysts, preferably of sulfuric acid or sulfonic acids, e.g. para-toluenesulfonic acid or dodecylbenzenesulfonic acid, and, if required, (meth)acrylic acid or oligomeric (meth)acrylic acid into useful products ((meth)acrylic acid, alcohol, desired ester) (cf. for example DE-A 195 47 459 and DE-A 195 47 485).

The higher esters obtained by esterification using crystals according to the novel process and lower esters obtained from mother liquor are present as a rule as mixtures which may contain the following components:

| | Higher esters | Lower esters |
|---|---|---|
| Purity | at least 99.8, | at least |
| | preferably at least 99.9, % | 99.5% by |
| | by weight | weight |
| Acetates | 300, preferably 100, | 500 ppm by |
| | particularly preferably 50, | weight or |
| | ppm by weight or less | less |
| Propionates | 200, preferably 100, | 1 000 ppm by |
| | particularly preferably 50, | weight or |
| | ppm by weight or less | less |

Of course, at least a part of the crystals A can also be used for the preparation of lower (meth)acrylates if, for example, the product to be prepared has to meet high requirements or the polymer dispersion, suspensions or emulsions to be prepared cannot be deodorized owing to its temperature sensitivity (see above). At least a part of the mother liquor B can also be used for the preparation of (meth)acrylic acid-containing (co)polymers or higher (meth)acrylates if only low requirements have to be met.

In a preferred embodiment, from 10 to 100, preferably from 20 to 100, particularly preferably from 30 to 100, in particular from 50 to 100, % by weight of the crystals obtained by the novel process are used for the preparation of (co)polymers or higher (meth)acrylates.

The crystals not used for the preparation of (co)polymers or higher (meth)acrylates can be used at least partly, for example for the preparation of lower (meth)acrylates. Here, at least partly means that from 0 to 100, preferably from 15 to 100, particularly preferably from 30 to 100, in particular from 50 to 100, % by weight of the crystals not used for the preparation of (co)polymers or higher (meth)acrylates can be used for the preparation of lower (meth)acrylates.

In a further preferred embodiment, from 10 to 100, preferably from 20 to 100, particularly preferably from 30 to 100, in particular from 50 to 100, % by weight of the mother liquor are used for the preparation of lower (meth)acrylates. The preparation of aqueous polymer dispersions has been widely described in the past and is therefore sufficiently well known (for example, Encyclopedia of Polymer Science and Engineering, Vol. 8, 659 et seq., 1987; High Polymer Latices, Vol. 1, 35 et seq., 1966; Emulsion Polymerization, Interscience Publishers, New York, 1965; Chemie in unserer Zeit 24 (1990), 135-142; DE-A 40 03 422).

Substantially common to all preparation processes is that monomers which have at least one ethylenically unsaturated group are concomitantly used for synthesizing the polymer or that said polymer is synthesized exclusively from such monomers. Here, monoethylenically unsaturated monomers which can be subjected to free radical polymerization in a simple manner, for example C₁-C₁₂-alkyl esters of acrylic acid and methacrylic acid, are particularly important.

For example, the (meth)acrylates prepared according to the invention or the (meth)acrylic acid obtained as crystals A can be used for preparing (co)polymers and/or polymer dispersions in which the (co)polymer is composed of

A) from 50 to 100, preferably from 80 to 99.5, particularly preferably from 90 to 99, % by weight of at least one of the higher and/or lower (meth)acrylates prepared according to the invention and, if required, furthermore at least one monomer which is selected from vinylaromatics, such as styrene, α-methylstyrene, o-chlorostyrene and vinyltoluene; esters of vinyl alcohol and monocarboxylic acids of 1 to 18 carbon atoms, such as vinyl acetate, vinyl n-butyrate, vinyl propionate, vinyl laurate, vinyl pivalate and vinyl stearate, and commercially available monomers VEOVA® 9-11 (VEOVA X is a trade name of Shell and represents vinyl esters of carboxylic acids which are also referred to as versatic X acids); esters of allyl alcohol and monocarboxylic acids of 1 to 12 carbon atoms, such as allyl acetate and allyl propionate; esters of α,β-monoethylenically unsaturated mono- and dicarboxylic acids of, preferably, 3 to 6 carbon atoms, such as maleic acid, fumaric acid and itaconic acid, alkanols of in general 1 to 12, preferably 1 to 8, in particular 1 to 4, carbon atoms, for example dimethyl maleate and n-butyl maleate; acrylonitrile and methacrylonitrile; conjugated C₄₋₈-dienes, such as 1,3-butadiene and isoprene; olefins, such as vinyl chloride and vinylidene chloride, and

B) from 0 to 50, preferably from 0.5 to 20, particularly preferably from 1 to 10, % by weight of comonomers which is selected from α,β-monoethylenically unsaturated mono- and dicarboxylic acids of 3 to 6 carbon atoms and their amides, such as acrylic acid, methacrylic acid, dimethacrylic acid, ethacrylic acid, citraconic acid, methylenemalonic acid, allylacetic acid, vinylacetic acid, mesaconic acid, maleic acid, fumaric acid, itaconic acid and their water-soluble alkali metal, alkaline earth metal and ammonium salts, acrylamide and methacrylamide, and vinylsulfonic acid and its water-soluble salts; monoesters of C₂-C₄-diols with acrylic acid or methacrylic acid, such as hydroxyethyl (meth)acrylate, hydroxybutyl (meth)acrylate and hydroxypropyl (meth)acrylate; amino-C₂-C₄-alkyl (meth)acrylates and the N-mono- and N,N-dialkyl derivatives thereof; and N-vinylpyrrolidone and other N-vinyllactams, e.g. N-vinylcaprolactam, and N-vinyl-N-alkylcarboxamides and N-vinylcarboxamides, e.g. vinylformamide, N-vinylacetamide, N-vinyl-N-methylformamide and N-vinyl-N-methylacetamide, and monomers which usually increase the internal strength of the films of the aqueous polymer dispersions, suspensions or emulsions and normally have at least one epoxy, hydroxyl, N-methylol or carbonyl group or at least two nonconjugated ethylenically unsaturated double bonds. Examples of these are N-alkylolamides of α,β-monoethylenically unsaturated carboxylic acids of 3 to 10 carbon atoms and their esters with alkenols of 1 to 4 carbon atoms, among which N-methylolacrylamide and N-methylolmethacrylamide are very particularly preferred, monomers having two vinyl radicals, monomers having two vinylidene radicals and monomers having two alkenyl radicals.

A frequent method, but not the only one, for the preparation of the abovementioned (co)polymers is free radical or ionic (co)polymerization in a solvent or diluent.

The free radical (co)polymerization of such monomers is effected, for example, in aqueous solution in the presence of polymerization initiators which decompose into free radicals under polymerization conditions. The (co)polymerization can be carried out in a wide temperature range, if required under reduced or superatmospheric pressure, as a rule at up to 100° C. The pH of the reaction mixture is usually set in the range of from 4 to 10.

The (co)polymerization can, however, also be carried out continuously or batchwise in another manner known per se to a person skilled in the art, for example as a solution, precipitation, water-in-oil emulsion, inverse emulsion, suspension or inverse suspension polymerization. Solution polymerization is preferred.

There, the monomer/the monomers is or are (co)polymerized using free radical polymerization initiators, for example azo compounds decomposing in free radicals, such as 2,2′-azobisisobutyronitrile, 2,2′-azobis(2-amidinopropane) hydrochloride or 4,4′-azobis(4′-cyanopentanoic acid).

Said compounds are generally used in the form of aqueous solutions, the lower concentration being determined by the amount of water acceptable in the (co)polymerization and the upper concentration by the solubility of the relevant compound in water. In general, the concentration is from 0.1 to 30, preferably from 0.5 to 20, particularly preferably from 1.0 to 10, % by weight, based on the solution.

The amount of initiators is in general from 0.1 to 10, preferably from 0.5 to 5, % by weight, based on the monomers to be (co)polymerized. It is also possible to use a plurality of different initiators in the (co)polymerization.

For example, water, alcohols, such as methanol, ethanol, n-propanol, isopropanol, n-butanol or isobutanol, or ketones, such as acetone, methyl ethyl ketone, diethyl ketone or methyl isobutyl ketone, may serve as solvents or diluents.

If required, the (co)polymerization can be carried out in the presence of polymerization regulators, for example hydroxylammonium salts, chlorinated hydrocarbons and thio compounds, e.g. tert-butyl mercaptan, ethyl thioglycolate, mercaptoethanol, mercaptopropyltrimethoxysilane, dodecyl mercaptan or tert-dodecyl mercaptan, or alkali metal hypophosphites. In the (co)polymerization, these regulators can be used, for example, in amounts of from 0 to 0.8 part by weight, based on 100 parts by weight of the monomers to be (co)polymerized, by means of which the molar mass of the resulting (co)polymer is reduced.

Dispersants, ionic and/or nonionic emulsifiers and/or protective colloids or stabilizers may be used as surface-active compounds in the emulsion polymerization.

Suitable such compounds are both the protective colloids usually used for carrying out emulsion polymerizations and emulsifiers.

Suitable protective colloids are, for example, polyvinyl alcohols, cellulose derivatives and vinylpyrrolidone-containing copolymers. A detailed description of further suitable protective colloids is to be found in Houben-Weyl, Methoden der organischen Chemie, Volume XIV/1, makromolekulare Stoffe, Georg-Thieme-Verlag, Stuttgart, 1969, pages 411 to 420. Of course, mixtures of emulsifiers and/or protective colloids may also be used. Preferably, exclusively emulsifiers whose relative molecular weights are usually less than 1,000, in contrast to the protective colloids, are used as dispersants. Said emulsifiers may be either anionic, cationic or nonionic. Where mixtures of surface-active substances are used, the individual components must of course be compatible with one another, it being possible to do this by means of a few preliminary experiments in case of doubt. In general, anionic emulsifiers are compatible with one another and with nonionic emulsifiers.

The same also applies to cationic emulsifiers, whereas anionic and cationic emulsifiers are generally incompatible with one another. Customary emulsifiers are, for example, ethoxylated mono-, di- and trialkylphenols (degree of ethoxylation: from 3 to 100, alkyl radical: C₄ to C₁₂) , ethoxylated fatty alcohols (degree of ethoxylation: from 3 to 100, alkyl radical: C₈ to C₁₈) and alkali metal and ammonium salts of alkylsulfates (alkyl radical: C₈ to C₁₆), of sulfuric monoesters of ethoxylated alkylphenols (degree of ethoxylation: from 3 to 100, alkyl radical: C₄ to C₁₂), of alkanesulfonic acids (alkyl radical: C₁₂ to C₁₈) and of alkylarylsulfonic acids (alkyl radical: C₉ to C₁₈). Further suitable emulsifiers, such as sulfosuccinic esters, are described in Houben-Weyl, Methoden der organischen Chemie, Volume XIV/1, Makromolekulare Stoffe, Georg-Thieme Verlag, Stuttgart, 1961, pages 192 to 208.

As a rule, the amount of dispersant used is from 0.5 to 6, preferably from 1 to 3, % by weight, based on the monomers to be subjected to free radical polymerization.

Examples of (meth)acrylate-containing dispersions are n-butyl acrylate/acrylonitrile dispersions, which are used as adhesives, and n-butyl acrylate/butadiene/styrene dispersions, which are used in paper coating (cf. also Ullmann's Encyclopedia of Industrial Chemistry, 5th Ed., Vol. A21, 171-175). Further possible dispersions are those which contain 2-ethylhexyl acrylate and styrene as main components. Further components which may be present therein are, for example, methyl methacrylate, methacrylic acid or acrylic acid.

The polymer dispersions in which lower (meth)acrylates prepared according to the invention are used may additionally be physically deodorized.

The physical deodorization can be carried out in conventional apparatuses and under customary conditions (from 50 to 100° C., from 0.2 to 1 bar). It has proven particularly preferable to carry out the physical deodorization by the method described in DE 12 48 943 or in a countercurrent column. This is preferably equipped with trickle sieve trays and/or cross-flow sieve trays, preferably from 5 to 50 of these trays being used. The countercurrent column is preferably equipped in such a way that the specific free hole area in the trickle sieve trays is from 2 to 25% and that in the cross-flow sieve trays is from 1 to 10% and the mean hole diameter in the trickle sieve trays is from 10 to 50 mm and that in the cross-flow sieve trays is from 2 to 10 mm.

The stripping gas is preferably passed into the column at from 0.1 to 1.5, in particular from 0.2 to 0.7, bar, countercurrently to the dispersion.

Suitable countercurrent columns are described in DE-A 196 21 027 and DE-A 197 16 373, which are hereby fully incorporated by reference.

The dispersions, suspensions or emulsions obtained using (meth)acrylates prepared by the novel process generally contain, without deodorization, 100 ppm or less, preferably 50 ppm or less, of acetates, and 100 ppm or less, preferably 50 ppm or less, of propionates.

The pure (meth)acrylic acid obtainable as crystals A by the novel process can likewise be used at least partly for the preparation of (meth)acrylic acid-containing (co)polymers, particularly preferably for polyacrylic acid, in particular for superabsorbers.

The preparation of (meth)acrylic acid-containing (co)polymers, polyacrylic acids and superabsorbers has been widely described in the past and is therefore sufficiently well known, cf. for example Modern Superabsorbent Polymer Technology, F. L. Buchholz and A. T. Graham, Wiley-VCH, 1998.

For example, the (meth)acrylates obtainable by the novel process and the pure (meth)acrylic acid can be used, for example, for the preparation of (meth)acrylate adhesives, as described, for example, in G. Auchter, O. Aydin, A. Zettl and D. Satas, Acrylic Adhesives, Chapter 19 of Handbook of Pressure Sensitive Adhesive Technology, Donatas Satas (ed), 1999,.

These generally have the following composition:

Main monomer 50-98% by weight

Secondary monomer 10-40% by weight

Functionalized monomer 0.5-20% by weight.

There, main monomers are, for example, (meth)acrylates, vinyl chloride, vinyl esters, alkyl vinyl ketones, vinylaromatics, alkyl vinyl ethers, olefins or mixtures thereof.

Examples of suitable secondary monomers are

(meth)acrylates, (meth)acrylamides, acrolein, (meth)acrylonitrile, fumarates, maleates, maleonitrile, N-vinylamides, allylacetic acid, vinyl acetic acid and mixtures thereof.

Functionalized monomers, in addition to the (meth)acrylic acid prepared according to the invention, are, for example, those which carry carboxyl, hydroxyl, epoxy, allyl, carboxamido, amino, isocyanate, hydroxymethyl, methoxymethyl or silyloxy groups. These may be, for example, monoethylenically unsaturated carboxylic acids of 3 to 8 carbon atoms and their water-soluble alkali metal, alkaline earth metal or ammonium salts, for example acrylic acid, methacrylic acid, maleic acid, crotonic acid, fumaric acid and mixtures thereof.

The pure (meth)acrylic acids are preferably used for the preparation of polymers which are obtained by crosslinking polymerization or copolymerization of monoethylenically unsaturated monomers carrying acid groups or the salts of said monomers. It is also possible to (co)polymerize these monomers without crosslinking agents and subsequently to crosslink them.

Such monomers carrying acid groups are, for example, monoethylenically unsaturated C₃- to C₂₅-carboxylic acids or anhydrides, in addition to acrylic acid and methacrylic acid.

In order to optimize the properties of the (co)polymers, it may be expedient to use additional monoethylenically unsaturated compounds which carry no acid groups but are copolymerizable with the monomers carrying acid groups. These include, for example, the amides and nitriles of monoethylenically unsaturated carboxylic acids. Further suitable compounds are, for example, vinyl esters of saturated C₁- to C₄-carboxylic acids, alkyl vinyl ethers having at least 2 carbon atoms in the alkyl group, esters of monoethylenically unsaturated C₃- to C₆-carboxylic acids, monoesters of maleic acid, N-vinyllactams, acrylates and methacrylates of alkoxylated monohydric, saturated alcohols, for example of alcohols which have been reacted with from 2 to 200 moles of ethylene oxide and/or propylene oxide per mole of alcohol, and monoacrylates and monomethacrylates of polyethylene glycol or polypropylene glycol. Further suitable monomers are styrene and alkyl-substituted styrenes.

These monomers carrying no acid groups can also be used as a mixture with other monomers, for example mixtures of vinyl acetate and 2-hydroxyethyl acrylate in any desired ratio.

These monomers carrying no acid groups are added to the reaction mixture in amounts of from 0 to 50, preferably less than 20, % by weight.

The crosslinked (co)polymers preferably consist of monoethylenically unsaturated monomers which carry acid groups and may have been converted into their alkali metal or ammonium salts before or after polymerization, and of 0-40% by weight, based on their total weight, of monoethylenically unsaturated monomers carrying no acid groups.

Crosslinked polymers of monoethylenically unsaturated C₃- to C₁₂-carboxylic acids and/or their alkali metal or ammonium salts are preferred.

Crosslinked polyacrylic acids in which from 10 to 100, preferably from 30 to 95, particularly preferably from 50 to 90, mol %, based on the monomers containing acid groups, of acid groups are present as alkali metal or ammonium salts are particularly preferred.

Compounds which have at least two ethylenically unsaturated double bonds may act as crosslinking agents.

Other suitable crosslinking agents are compounds which contain at least one polymerizable ethylenically unsaturated group and at least one further functional group. The functional group of these crosslinking agents must be capable of reacting with the functional groups, substantially the acid groups, of the monomers. Suitable functional groups are, for example, hydroxyl, amino, epoxy and aziridino groups.

Further suitable crosslinking agents are compounds which contain at least two functional groups which are capable of reacting with the functional groups, substantially the acid groups, of the monomers.

Other suitable crosslinking agents are polyvalent metal ions which are capable of forming ionic networks.

The crosslinking agents are present in the reaction mixture in amounts of, for example, 0.001 to 20, preferably from 0.01 to 14, % by weight.

All processes which are usually used for the preparation of superabsorbers, as described, for example, in Chapter 3 in Modern Superabsorbent Polymer Technology, F. L. Buchholz and A. T. Graham, Wiley-VCH, 1998, can be used as industrial processes for the preparation of these products.

The polymerization in aqueous solution in the form of a gel polymerization is preferred. There, from 10 to 70% strength by weight aqueous solutions of the monomers and, if required, of a suitable grafting base are polymerized in the presence of a free radical initiator utilizing the Trommsdorff-Norrish effect.

The polymerization reaction can be carried out at from 0 to 150° C., preferably from 10 to 100° C., at atmospheric, superatmospheric or reduced pressure.

As usual, the polymerization can also be carried out in a gas atmosphere, preferably under nitrogen.

By subsequently heating the polymer gels for several hours at from 50 to 130° C., preferably from 70 to 100° C., the quality properties of the polymers can be further improved.

The acidic hydrogel-forming polymers thus obtained are very useful as absorbents for water and aqueous liquids, so that they can be advantageously used as water-retaining compositions in horticulture, as filtration aids and in particular as absorptive components in hygiene articles, such as diapers, tampons or sanitary towels.

Hydrogel-forming polymers are frequently postcrosslinked at the surface. The surface postcrosslinking can be effected in a manner known per se by means of dried, milled and sieved polymer particles.

For this purpose, compounds capable of reacting with the functional groups of the polymers with crosslinking, preferably in the form of a water-containing solution, are applied to the surface of the hydrogel particles. The water-containing solution may contain water-miscible organic solvents. Suitable solvents are, for example, alcohols, such as methanol, ethanol or isopropanol, and acetone.

In the postcrosslinking, polymers which are prepared by polymerization of the abovementioned monoethylenically unsaturated acids and, if required, monoethylenically unsaturated comonomers and which have a molecular weight greater than 5,000, preferably greater than 50,000, are reacted with compounds which have at least two groups reactive toward acid groups. This reaction can be carried out at room temperature or at elevated temperatures up to 220° C.

Examples of suitable postcrosslinking agents are

di- or polyglycidyl compounds, such as phosphonic acid diglycidyl ether or ethylene glycol diglycidyl ether, bischlorohydrin ethers of polyalkylene glycols,

alkoxysilyl compounds,

polyaziridines, compounds containing aziridine units and based on polyethers or substituted hydrocarbons, for example bis-N-aziridinomethane,

polyamines or polyamidoamines and their reaction products with epichlorohydrin,

polyols, such as ethylene glycol, 1,2-propanediol, 1,4-butanediol, glycerol, methyltriglycol, polyethylene glycols having an average molecular weight M_{w} of 200-10,000, di- and polyglycerol, pentaerythritol, sorbitol, the oxyethylates of these polyols and their esters with carboxylic acids or with carbonic acid, such as ethylene carbonate or propylene carbonate,

carbonic acid derivatives, such as urea, thiourea, guanidine, dicyandiamide, 2-oxazolidone and its derivatives, bisoxazoline, polyoxazolines and di- and polyisocyanates,

di- and poly-N-methylol compounds, for example methylenebis(N-methylolmethacrylamide), or melamine/formaldehyde resins,

compounds having two or more blocked isocyanate groups, for example trimethylhexamethylene diisocyanate blocked with 2,2,3,6-tetramethylpiperidin-4-one.

If required, acidic catalysts, for example p-toluenesulfonic acid, phosphoric acid, boric acid or ammonium dihydrogen phosphate, may be added.

Particularly suitable postcrosslinking agents are di- or polyglycidyl compounds, such as ethylene glycol diglycidyl ether, the reaction products of polyamidoamines with epichlorohydrin and 2-oxazolidinone.

The crosslinker solution is preferably applied by spraying on a solution of the crosslinking agent in conventional reaction mixers or mixing and drying units, for example Patterson-Kelly mixers, DRAIS turbulent mixers, Lödige mixers, screw mixers, pan mixers, fluidized-bed mixers and Schugi-Mix. Spraying on of the crosslinker solution may be followed by a thermal treatment step, preferably in a downstream dryer, at from 80 to 230° C., preferably 80-190° C., particularly preferably from 100 to 160° C., for a period of from 5 minutes to 6 hours, preferably from 10 minutes to 2 hours, particularly preferably from 10 minutes to 1 hour, it being possible to remove both cleavage products and solvent fractions. The drying can also be effected in the mixer itself, by heating the jacket or blowing in a heated carrier gas.

Furthermore, the hydrophilic properties of the particle surface of the hydrogel-forming polymers can be additionally modified by formation of complexes. The complexes are then formed on the outer shell of the hydrogel particles by spraying on divalent or polyvalent metal salt solutions, the metal cations being capable of reacting with the acid groups of the polymer with formation of complexes. Examples of divalent to polyvalent metal cations are Mg²⁺, Ca²⁺, Al³⁺, Sc³⁺, Ti⁴⁺, Mn²⁺, Fe^{2+/3+}, Co²⁺, Ni²⁺, Cu^{+/2+}, Zn²⁺, Y³⁺, Zr⁴⁺, Ag⁺, La³⁺, Ce⁴⁺, Hf⁴⁺ and Au^{+/3+}, preferred metal cations being Mg²⁺, Ca²⁺, Al³⁺, Ti⁴⁺, Zr⁴⁺ and La³⁺, particularly preferred metal cations being Al³⁺, Ti⁴⁺ and Zr⁴⁺. The metal cations may be used both alone and as a mixture with one another. Suitable among said metal cations are all metal salts which have sufficient solubility in the solvent to be used. Metal salts having weakly complexing anions, for example chloride, nitrate and sulfate, are particularly suitable. Water, alcohols, dimethylformamide, dimethyl sulfoxide and mixtures of these components may be used as solvents for the metal salts. Water and water/alcohol mixtures, for example water/methanol or water/1,2-propanediol, are particularly preferred.

The metal salt solution can be sprayed onto the particles of the hydrogel-forming polymer both before and after the surface postcrosslinking of the particles. In a particularly preferred process, the spraying on of the metal salt solution is effected in the same step as the spraying on of the crosslinker solution, it being possible to spray on the two solutions separately in succession or simultaneously via two nozzles or to spray on crosslinker solution and metal salt solution together via one nozzle.

A further modification of the hydrogel-forming polymers by admixing of finely divided inorganic solids, for example silica, alumina, titanium dioxide and iron(II) oxide, can optionally also be effected, with the result that the effects of the surface aftertreatment are further enhanced. The admixing of hydrophilic silica or of alumina having a mean primary particle size of from 4 to 50 nm and a specific surface area of 50-450 m²/g is particularly preferred. The admixing of finely divided inorganic solids is preferably effected after the surface modification by crosslinking/complex formation but can also be carried out before or during these surface modifications.

### EXAMPLES

In the examples which follow, parts, percentages and ppm data are by weight.

### Example 1 (One-stage Crystallization)

The crystallization was carried out in a stirred container with double-wall cooling and a helical stirrer passing close to the wall. The crystals were separated from the mother liquor in a heatable centrifuge (2,000 rpm, centrifuging time 5 minutes). The crystals were washed with an acrylic acid (molten crystals which had been washed beforehand; about 20% by weight, based on crystals, 50 seconds, 2,000 rpm). The analysis of the crystals, of the mother liquor or of the starting acid was carried out by means of gas chromatography (cf. table 1). The crude acrylic acid used was prepared according to German Laid-Open Application DOS 43 08 087, example B-a). The crystals/mother liquor separation was effected in the ratio of 40:60 (w/w).

TABLE 1

| | Crude acrylic | | | | Mother | |
|---|---|---|---|---|---|---|
| | acid | | Crystals | | liquor | |
| Acrylic acid | 99.70% | | 99.95% | | 99.55% | |
| Acetic acid | 1400 | ppm | 240 | ppm | 2110 | ppm |
| Propionic acid | 220 | ppm | 70 | ppm | 310 | ppm |
| Maleic acid | 20 | ppm | <5 | ppm | 35 | ppm |
| Phenothiazine | 260 | ppm | 35 | ppm | 385 | ppm |
| Water | 800 | ppm | 100 | ppm | 1100 | ppm |

### Example 2 (Two-stage Crystallization)

The crystallization apparatus described in example 1 was used.

The crystallization was carried out in two stages, i.e. the crystals of the 1st crystallization were melted and were crystallized again. The washing of the crystals was effected in each case with the end product analogously to example 1, the 1st wash liquid being added to the mother liquor for the 1st crystallization, and the wash liquid of the 2nd crystallization being fed together with the mother liquor of the 2nd crystallization back to the 1st crystallization. The overall results are summarized in table 2. The crude acrylic acid used was prepared according to DE-A 199 24 532, example 1.

TABLE 2

| | Crude acrylic | | | | Mother | |
|---|---|---|---|---|---|---|
| | acid | | Crystals | | liquor | |
| Acrylic acid | 97.30% | | 99.92% | | 96.15% | |
| Acetic acid | 1.2% | | 240 | ppm | 1.7% | |
| Propionic acid | 420 | ppm | 50 | ppm | 580 | ppm |
| Maleic acid | 40 | ppm | <5 | ppm | 55 | ppm |
| Phenothiazine | 300 | ppm | <10 | ppm | 420 | ppm |

| | | | | |
|---|---|---|---|---|
| Water | 1.3% | 500 | ppm | 1.9% |

### Example 3 (Esterification, 2-ethylhexyl Acrylate)

A mixture of 2,600 parts of 2-ethylhexanol, 1,600 parts of acrylic acid (crystals) from example 2, 1,500 parts of cyclohexane, 60 parts of sulfuric acid and 0.5 part of phenothiazine was heated to the boil in a 10 l stirred reactor having double wall heating and an attached column. The resulting water of reaction was removed via the column as an azeotropic mixture with cyclohexane and was condensed. The condensate separated into an organic phase, which was completely recycled to the column, and an aqueous phase, which was discharged. After a reaction time of 5 hours, the esterification mixture was cooled to 20° C. and washed in succession with 700 parts of water, 800 parts of 20% strength sodium hydroxide solution and 500 parts of water. The organic phase was worked up by distillation, first the low-boiling components being separated off and then the 2-ethylhexyl acrylate being isolated with a purity of 99.97%. The 2-ethylhexyl acetate content and ethylhexyl propionate content were 30 ppm and 50 ppm, respectively.

### Example 4 (Esterification, n-butyl Acrylate)

A mixture of 2 850 parts of n-butanol, 2 530 parts of acrylic acid-containing mother liquor from example 1, 60 parts of sulfuric acid and 0.5 part of phenothiazine was heated to the boil in a 10 l stirred reactor having double wall heating and an attached column. The resulting water of reaction was removed via the column with small amounts of butanol and butyl acrylate/butyl acetate and was condensed. The condensate separated into an organic phase, which was completely recycled to the column, and an aqueous phase, which was discharged. After a reaction time of 4 hours, the esterification mixture was cooled to 20° C. and was washed in succession with 500 parts of water, 500 parts of 20% strength sodium hydroxide solution and 500 parts of water. The organic phase was worked up by distillation, first the low-boiling components being separated off and then the butyl acrylate being isolated with a purity of 99.88%. The n-butyl acetate content and n-butyl propionate content were 220 ppm and 310 ppm, respectively.

### Example 5 (Esterification, n-butyl Acrylate)

A mixture of 2 850 parts of n-butanol, 2 600 parts of acrylic acid-containing mother liquor from example 2, 60 parts of sulfuric acid and 0.5 part of phenothiazine was heated to the boil in a 10 l stirred reactor having double wall heating and an attached column. The resulting water of reaction was removed via the column with small amounts of butanol and butyl acrylate/butyl acetate and was condensed. The condensate separated into an organic phase, which was completely recycled to the column, and an aqueous phase, which was discharged. After a reaction time of 4 hours, the esterification mixture was cooled to 20° C. and was washed in succession with 500 parts of water, 500 parts of 20% strength sodium hydroxide solution and 500 parts of water. The organic phase was worked up by distillation, first the low-boiling components being separated off and then the butyl acrylate being isolated with a purity of 99.81%. The n-butyl acetate content and n-butyl propionate content were 340 ppm and 570 ppm, respectively.

### Example 6 (n-butyl Acrylate-containing Dispersion)

Starting from the butyl acrylates prepared in examples 4 and 5, n-butyl acrylate/acrylonitrile dispersions (solids content 55%) were prepared in a known manner by emulsion polymerization. The butyl acetate content of the dispersions was 80 and 100 ppm and the propionate content was 100 and 200 ppm. These dispersions were deodorized, as described in DE-A 197 16 373, with 25% by weight of steam in a dual-flow column (8 trays, opening ratio 0.02). After a single pass, the n-butyl propionate or n-butyl acetate content was <20 ppm.

### Example 7 (2-ethylhexyl Acrylate-containing Dispersions)

Starting from the 2-ethylhexyl acrylate prepared in example 3, Acronal® V 210 (69% solids content, BASF AG), a dispersion used as a pressure sensitive adhesive, was prepared by emulsion polymerization. The 2-ethylhexyl acetate content and 2-ethylhexyl propionate content were <10 ppm and <20 ppm, respectively. Deodorization was therefore not necessary.

### Example 8 (2-ethylhexyl Acrylate-containing Dispersion—comparison)

Starting from a 2-ethylhexyl acrylate of conventional quality which contained 290 ppm of 2-ethylhexyl propionate and 460 ppm of 2-ethylhexyl acetate, the dispersion Acronal V 210 was prepared analogously to example 7. The propionate content and acetate content of the dispersion were 140 ppm and 210 ppm, respectively. After the physical deodorization according to example 6, the 2-ethylhexyl propionate content and 2-ethylhexyl acetate content was still 100 ppm and 110 ppm, respectively.

### Example 9, Superabsorber Preparation From Acrylic Acid Crystals

Under adiabatic conditions, 1,000 g of demineralized water cooled to 15° C. were initially taken in a cylindrical 2 l wide-necked reaction flask and 400 g of acrylic acid from example 2 and 3.4 g of tetraallyloxyethane were dissolved therein. Nitrogen was passed into the monomer solution (about 2 l/min for about 30 minutes) in order to reduce the oxygen content. Thereafter, 7.7 g of a 10% strength aqueous solution of 2,2′-azobis(2-amidinopropane) dihydrochloride were added, 2.6 g of a 1% strength H₂O₂ solution were added after further introduction of N₂, and an O₂ content of 1.3 ppm, and finally 6.4 g of 0.1% strength ascorbic acid solution were added at an O₂ content of 1.0 ppm. A solid gel formed through the resulting polymerization, in the course of which the temperature increased to about 85° C., and was then mechanically comminuted. 10 g of soda waterglass, (27% strength by weight, based on SiO₂ and 14% strength by weight based on NaOH), dissolved in 228.2 g of 50% strength hydroxide solution, were added to 1,000 g of the comminuted gel (degree of neutralization of the acrylic acid 74 mol %) and passed twice through a mixer-extruder, and the resulting gel particles were milled and sieved at temperatures above 150° C.

For the determination of the extractables, 10 g of the polymer in 2,000 ml of 0.9% strength by weight sodium chloride solution was stirred for 16 hours in a beaker. Thereafter, filtration was effected through a 0.22 μm filter and the content of extractables was determined by acid-based titrations; it was 3.4%. After concentration (about 20:1), the acetic acid content and propionic acid content were determined by ion chromatography. They were <100 ppm and <30 ppm, respectively (based on gel).

### Example 10, Superabsorber Preparation From Standard Acrylic Acid

The procedure was as in example 9. The starting acrylic acid used was an acrylic acid purified in a conventional manner by distillation and having substantially the following composition:

| | | |
|---|---|---|
| Acrylic acid | 99.75% | |
| Acetic acid | 1 100 | ppm |
| Propionic acid | 300 | ppm |
| Inhibitor | 200 | ppm of hydroquinone |
| | | monomethyl ether |

The amount of extractables was 3.7%. The acetic acid content was about 500 ppm and the propionic acid content was about 100 ppm (based on gel).

### Example 11, Superabsorber Preparation From Crude Acrylic Acid

The procedure was as in example 9. The starting acrylic acid used was the same crude acrylic acid as for example 1.

No gel could be prepared in this manner.

We claim:

1. A process for the preparation of pure (meth)acrylic acid and lower (meth)acrylates from crude (meth)acrylic acid, wherein
I) crude (meth)acrylic acid is separated into at least one crystal batch A and at least one mother liquor B and
II) at least a part of the crystal batch A is removed as pure (meth)acrylic acid and at least a part of the mother liquor B is used for the preparation of lower (meth)acrylates by esterifying (meth)acrylic acid with the corresponding alcohols in the presence of an acidic catalyst.

2. A process as claimed in claim 1, wherein at least a part of the crystal batch A is used for the preparation of higher (meth)acrylates by esterifying (meth)acrylic acid with the corresponding alcohols in the presence of an acidic catalyst.

3. A process as claimed in claim 2, wherein the higher (meth)acrylates are obtained by esterifying alcohols of 6 to 12 carbon atoms and the lower (meth)acrylates are obtained by esterifying alcohols of 1 to 4 carbon atoms.

4. A process as claimed in claim 1, wherein at least a part of the crystal batch A is used for the preparation of (meth)acrylic acid-containing polymers or copolymers.

5. A process as claimed in any of claims 1 to 4, wherein the crystallization is carried out in from one to three stages.

6. A process as claimed in any of claims 1 to 5, wherein the crystallization is effected statically.

7. A process as claimed in any of claims 1 to 6, wherein the crystallization is effected as a layer crystallization.

8. A process as claimed in any of claims 1 to 5, wherein the crystallization is effected as a suspension crystallization.

9. A process as claimed in any of claims 1 to 8, wherein the crystals and mother liquor are separated in a weight ratio of 20-80:80-20.

10. A process as claimed in any of claims 1 to 9, wherein the crystals are treated after the crystallization by washing and/or sweating.

11. A mixture containing higher (meth)acrylates, acetates and propionates, obtainable by a process as claimed in any of claims 2 to 10, containing 100 ppm by weight or less of acetates and 100 ppm by weight or less of propionates.

12. Lower (meth)acrylates obtainable by esterifying (meth)acrylic acid with the corresponding alcohols in the presence of an acidic catalyst, wherein at least a part of the crystal batch A is used for the preparation of the lower (meth)acrylate.

13. The use of (meth)acrylates, as claimed in claim 11 or 12 or prepared by a process as claimed in any of claims 1 to 10, for the preparation of polymer dispersions.

14. A polymer dispersion obtainable by polymerization or copolymerization of at least one (meth)acrylate as claimed in claim 11 or 12, with or without one or more other monomers.

15. A polymer dispersion containing (meth)acrylates in polymerized or copolymerized form, wherein the dispersion contains 50 ppm by weight or less of acetates and 50 ppm by weight or less of propionates.

16. The use of at least a part of the crystal batch A as claimed in claim 1 or any of claims 4 to 10 for the preparation of (meth)acrylic acid-containing polymers or copolymers.

17. The use of at least a part of the crystal batch A as claimed in claim 1 or any of claims 4 to 10 for the preparation of superabsorbers.
